(19) United States
(12) Patent Application Publication
(10) Pub. No.: US 2010/0186737 A1
(43) Pub. Date: Jul. 29, 2010

(54) Sugar Aeration Clarifier

(76) Inventor: Stuart Johnathan Ward, Camas, WA (US)

Correspondence Address: Stuart Ward, 19215 SE 34th St, Ste 106-202, Camas, WA, 98607, US

(21) Appl. No.: 12/683,307

(22) Filed: Jan. 6, 2010

Related U.S. Application Data
(60) Provisional application No. 61/146,955, filed on Jan. 23, 2009.

(51) Int. Cl. C13D 3/16

(52) U.S. Cl. 127/12

(57) ABSTRACT

Device for clarifying sugar syrup from a sugared juice, such as raw juice from sugar cane or from sugar beet, containing sugar and impurities. The device includes the sub-systems for facilitating coagulation and flocculation of the sugar syrup in order to obtain a clarified syrup, aeration filtration of the sugar syrup in order to obtain a retentate (mud) and a filtrate (clarified syrup), concentration of the retentate at the surface of the sugar syrup, further concentration of retentate during its removal from the sugar syrup surface, steps and device in order to obtain clarified syrup and mud in order that they are both subjected to further sugar mill refining operations.

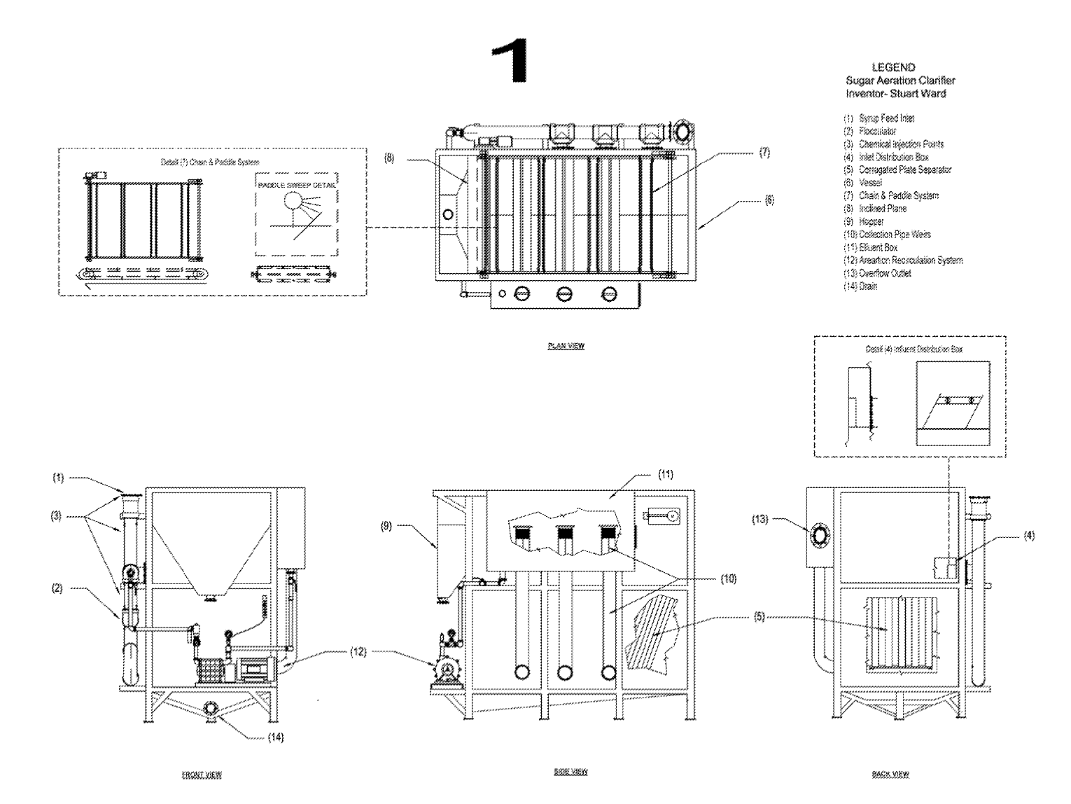

This application claims priority to Provisional Application No. 61/146,955 filed on Jan. 23, 2009.

The subject of the present invention is a device for producing clarified sugar syrup from sugared juice, such as a raw juice from sugar cane or from sugar beet.

At present, the production of sugar (or white sugar) from sugar cane comprises a certain number of treatments implemented in a sugar mill, followed by a certain number of supplementary treatments implemented in a refinery.

Schematically, the principal treatment steps in the sugar mill are the extraction of the sugar by crushing—pressing of the cane or by diffusion which leads to a raw sugared juice, the clarification of this juice by addition of lime, neutralization of the latter by carbon dioxide (in the case of sugar beet) or acids and decantation of the thus treated juice, the concentration of the resulting juice and finally the crystallization and spinning of the sugar generally in three steps, which leads to raw sugar and molasses being obtained. In the refinery, the operations to which the raw sugar is subjected are essentially a fining (washing of the crystals with a saturated aqueous sugar solution then spinning) in order to eliminate the impurities situated on the surface of the crystals, re-dissolving of the resulting sugar, a further clarification step, a decolorization, a crystallization and a spinning. Because of the relatively high purity of the syrup which is subjected to this crystallization, the latter operation is more difficult than in the sugar mill and requires two to three crystallization/separation steps, the purity of the run-off from the last crystallization/separation step is still very high and the sugar which it contains is extracted by a complementary crystallization of 3 or 4 steps, termed crystallization “of low grade sugars”, which leads to the production of a very colored sugar, which is recycled at the head of the refinery, and of molasses. It will be noted that because of the high viscosity of the product subjected to this crystallization, the latter is costly in material and in energy.

For several years, a certain number of methods and devices have been studied in order to improve the quality of the sugar at the level of the sugar mill.

Thus, Kwock et al. proposed, in the U.S. Pat. No. 5,554,227, a method leading to the production of a raw sugar with low coloration termed SVLC “Super Very Low Color” by linking the operations of filtration over a membrane, of softening and of crystallization. This method permits a simplification of the refining of the raw sugar and in particular the elimination of the operations of fining and purification. It permits likewise the implementation of a chromatography step in order to recover the sugar from the molasses and thus to improve the extraction yield of the sugar mill. This chromatography generally leads to the production of two fractions, i.e. an extract rich in sugar and a raffinate containing the impurities from the sugar.

McKearny et al. proposed for their part, in the international application WO 95/16 794, chromatography as a means of purification of the juices from sugar beet after their clarification, softening and concentration and before crystallization. This document shows that, starting from syrup with purity (percentage by weight of sugar with respect to the dry material) of approximately 90%, chromatography permits this purity to be raised to at least 94%. The crystallization of such syrup in three crystallization/separation steps gives a white sugar and molasses with a purity of approximately 60%.

However, the application of this method to sugar cane juice is inconceivable from an economic point of view.

In fact the production of white sugar from sugar cane juice requires starting from a syrup having a purity which is much higher than that of a sugar beet syrup, i.e. of the order of 98% instead of 94%. In these conditions, it becomes impossible to produce white sugar with a good yield by means of crystallization with 3 crystallization/separation steps because, in order to preserve the quality of the produced sugar, it is not possible to crystallize more than 50 to 60% of the sugar present, at each crystallization/separation step.

One solution to this problem would be to prolong the crystallization by 2 or 3 crystallization/separation steps termed depletion steps, which comes to reproducing crystallization of low grade products implemented in the refinery, and the avoidance of which is precisely what is being sought.

The object of the present invention is therefore to resolve the aforementioned problem in an economical manner and in order to do this a production device for refined sugar (or white sugar) is proposed starting from a sugared juice, such as raw juice from sugar cane or from sugar beet, containing sugars and impurities, this device being characterized in that it comprises the operations of:

The starting material used in this device is the sugar syrup concentrated from raw sugar cane juice, for example obtained by crushing—pressing of the sugar canes, which leads to a fibrous residue (bagasse) and a raw juice; as a variation, recourse can be had to the diffusion technique comprising depleting the sugar canes, cut into fragments, by hot water, which leads to a residue and to a raw juice. It goes without saying that the raw starting syrup could likewise be a raw juice from sugar beet.

The aforementioned concentrated raw sugar syrup, which contains sugars and non-sugars is subjected to a process using the “sugar aeration clarifier” device consisting of:

an intermediate continuous flow reaction of the sugared syrup passing through an enclosed pipe chamber (flocculator) for a holding period of 5 to 120 seconds in order to facilitate chemical coagulation and flocculation of the sugared syrup contaminant particle's agglomeration;

aeration of the sugared syrup within the flocculator from a regenerative turbine pump recirculation system to further agglomerate the particles in order to begin formation of a retentate and a filtrate;

the invention furthermore passes the aerated sugared syrup from the flocculator into the vessel where it is evenly distributed by means of an inlet distribution box;

separation of the retentate from the filtrate by means of passing the aerated sugar syrup through a corrugated plate separator composed of multiple plates angled at 55-65 degrees which facilitate laminar flow conditions as well as provide a separation surface for the agglomerating retentate particles;

concentration of the retentate (mud) at the surface of the sugar syrup within the vessel in order to obtain a floating skimmable mud;

further concentration of the retentate (mud) by means of a chain and paddle skimmer system moving across the syrup surface and up an inclined plane such that any filtrate (clarified syrup) returns to the vessel and the thickened mud is removed to the hopper for further mill processing;

and final extraction of the clarified syrup filtrate from the vessel through effluent collection pipe weirs for further mill processing.

Thus, in accordance with the present invention there is a removal of impurities and decolorization of the sugar syrup by the “sugar aeration clarifier” step following the mill sugar juice concentration operation.

Advantageously, the device according to the invention comprises furthermore a clarification operation of the sugared juice before it is subjected to the further process operation; this clarification eliminates the non-dissolved materials.

There is therefore reduced production of molasses at later processing steps within the mill, the non-sugars (impurities) from the sugared syrup being eliminated and the clarified syrup being recovered in the extract fraction of said device, which increases the global yield.

The device according to the invention is furthermore operated on a continuous flow basis within an operating temperature of 135F to 190 F.

The device according to the invention is furthermore operated on a continuous flow basis with an aeration recirculation system using a regenerative turbine pump discharge pressure of 20-100 psi fed with sugar syrup from the effluent box mixed with either ambient air or compressed air, according to operator preference. Additionally, the aeration recirculation system generates 20-30 micron bubbles at a gas saturation rate 6-10% by volume of re-circulated sugar syrup. The sugar syrup is re-circulated at a rate of 10-50% of the sugar aeration clarifier influent feed rate.

The device according to the invention is furthermore operated with a total retention time of 10 to 30 minutes.

The device according to the invention furthermore floats the retentate to the surface of the vessel whereby it is concentrated and skimmed by pushing it up an inclined plane of 30-50 degrees pitch with a chain and paddle system. The collected mud is then dropped into a hopper for removal to further mill processing.

The device according to the invention furthermore passes the clarified syrup out of the vessel through effluent weir piping.

The device according to the invention can furthermore comprise a decolorization operation of the filtrate, before it is subjected to the later crystallization operation; this decolorization is captured within the retentate mud.

One embodiment of the present invention is described hereafter with reference to the attached single DRAWING which is a schematic representation of the device according to the invention.

A BRIEF DESCRIPTION OF THE DRAWING illustrates the object of the “sugar aeration clarifier” clarification process is to eliminate the major portion of the impurities and/or suspended solid materials in the sugar syrup. The DRAWING includes several views of the “sugar aeration clarifier”. The FRONT VIEW illustrates the common components visible from that perspective. The SIDE VIEW illustrates the common components visible from that perspective, as well as cut-away internal views of the Corrugated Plate Separator and the Collection Pipe Weir components for further clarity. The BACK VIEW illustrates the common components visible from that perspective, as well as cut-away internal views of the Corrugated Plate Separator and the Inlet Distribution Box components for further clarity. Additionally, the BACK VIEW has a captioned DETAIL (4) more closely illustrating the Inlet Distribution Box. The PLAN VIEW illustrates the common components visible from that perspective. Additionally, the PLAN VIEW has a captioned DETAIL (7) more closely illustrating the Chain & Paddle System. For this purpose, the raw juice is supplied directly from the mill sugar juice concentrator (or an intermediate holding tank) to the “sugar aeration clarifier” as a sugar syrup to the feed inlet (1 FRONT VIEW) after having been heated preferably to 135-190F degree, for example by means of an indirect heat exchanger. In the flocculator (2 FRONT VIEW), it is mixed under brisk agitation with or without dosed chemistry for a continuous flow holding period of 5 to 120 seconds, the chemistry supplied to the latter in a staged injection process at multiple points (3 FRONT VIEW) along the flocculator (2 FRONT VIEW).

The sugar syrup is then directed into and evenly distributed within the vessel (6 PLAN VIEW) by means of an inlet distribution box (4 BACK VIEW and captioned DETAIL 4). The sugar syrup then passes in a “cross-counter” flow manner through a corrugated plate separator (5 FRONT VIEW and BACK VIEW) angled at 55-65 degrees which facilitates laminar flow conditions as well as provides a separation surface for the agglomerating retentate particles to further form. “Cross-counter” is defined as the syrup flowing across the vessel (6 PLAN VIEW) and downward towards the filtrate collection pipe weirs (10 SIDE VIEW) while the agglomerated retentate particles float upward in the counter direction toward the surface, thus a “cross-counter” flow.

The agglomerated retentate particles mixed with air float to the surface of the vessel (6 PLAN VIEW) where they are concentrated and skimmed by means of a chain and paddle system (7 PLAN VIEW and captioned DETAIL 7), the agglomerated particles are thickened as they are moved up the inclined plane (8 PLAN VIEW), with the clarified syrup filtrate draining back to the vessel (6 PLAN VIEW). The retentate (mud) is removed for further mill processing to a hopper (9 SIDE VIEW) at the top and adjacent to the inclined plane (8 PLAN VIEW).

The clarified syrup filtrate is then directed into and passes through collection pipe weirs (10 SIDE VIEW) and further flows up to an effluent box (11 SIDE VIEW) or “clear well”. From the effluent box (11 SIDE VIEW) a 10 to 50 percent portion of the clarified syrup is recirculated back to the flocculator (2 FRONT VIEW) through the aeration system (12 FRONT VIEW and SIDE VIEW) with a regenerative turbine pump. Alternatively an injection point at the side of the vessel could be used for the aeration recirculation return. The remaining clarified syrup is removed from the effluent box (11 SIDE VIEW) via an overflow outlet (13 BACK VIEW), or alternatively a pump.

Rentate solids having a density such that they sink to the bottom of the vessel (6 PLAN VIEW) rather than float for skimming by the chain and paddle system (7 PLAN VIEW and captioned DETAIL 7) may be removed via a drain (14 FRONT VIEW) located at the bottom of the vessel (6 PLAN VIEW).

Thus the clarified and decolored sugar syrup filtrate is then supplied to the mill for further processing.

And the retentate “mud”, is supplied to the mill for further reprocessing.

In addition, with respect to a conventional sugar mill, the device according to the invention permits an extraction yield of the sugar calculated at the entry to the crystallization workshop which goes to over 99%.

I claim:

1. Device for producing clarified sugar syrup from sugared juice, such as raw juice from sugar cane or from sugar beet, containing sugar and impurities, which comprises the operations of coagulation and flocculation of the sugared syrup in order to obtain a clarified filtrate, aeration filtration of the sugared syrup in order to obtain a retentate (mud) and a filtrate (clarified syrup), concentration and dewatering of the retentate, steps in order to obtain filtrate and retenate in order that they may both subjected to further independent sugar mill refining operations.

2. Device according to claim 1, characterized in that it comprises furthermore an enclosed pipe chamber, the “flocculator” for the facilitating an intermediate continuous flow reaction process resulting from the addition of organic and/or inorganic chemical coagulants and flocculants, such as cationic polymer, phosphoric acid, lime, and anionic polymer, as a pretreatment operation for aiding the removal of impurities and decolorization of the filtrate when it is subjected to the sugar aeration clarification operation.

3. Device according to claim 1, characterized in that it comprises furthermore an aeration filtration operation utilizing a regenerative turbine pump recirculation system.

4. Device according to claim 1, characterized in that it comprises furthermore a concentration operation of the extracted retentate or “mud”.

5. Device according to claim 1, characterized in that it comprises: a sugar aeration clarifier featuring a flotation vessel, a means of evenly distributing the influent sugar syrup, a means of separating the agglomerated particles from the clarified sugar syrup by passing the solution through a separator plate pack assembly, a means of aerating and floating the agglomerated solid retentate particles to the surface of the vessel for collection, a means of sweeping the agglomerated solids up an inclined surface, a means of collecting the solids in a hopper basin for transfer to further mill processes, a means of extracting the clarified sugar syrup filtrate from the vessel with adjustable effluent weirs for further mill processes.
